(19) United States
(12) Patent Application Publication
(10) Pub. No.: US 2020/0269578 A1
(43) Pub. Date: Aug. 27, 2020

(54) Liquid Discharge Head

(71) Applicant: Brother Kogyo Kabushiki Kaisha, Nagoya-shi (JP)

(72) Inventor: Hideki Hayashi, Nagoya-shi (JP)

(21) Appl. No.: 16/723,039

(22) Filed: Dec. 20, 2019

(30) Foreign Application Priority Data
Feb. 21, 2019 (JP) 2019-029168

(51) Int. Cl. B41J 2/14

(52) U.S. Cl. CPC B41J 2/14233; B41J 2002/14419

(57) ABSTRACT

There is provided a liquid discharge head including: a channel unit that includes nozzles, pressure chambers communicating with the respective nozzles and arranged in an arrangement direction, and a manifold; and a pressure applying mechanism that applies discharge pressure to a liquid in the pressure chambers. The manifold includes: a lower portion extending in the arrangement direction at a lower side of the pressure chambers and communicating with the pressure chambers to supply the liquid from an outside to the pressure chambers; a coupling portion having a lower end connected to the lower portion and an upper end positioned at an upper side of the lower end; and an upper portion having an end connected to the upper end of the coupling portion and extending in the arrangement direction at the upper side of the pressure chambers.

### CROSS REFERENCE TO RELATED APPLICATION

The present application claims priority from Japanese Patent Application No. 2019-029168 filed on Feb. 21, 2019, the disclosure of which is incorporated herein by reference in its entirety.

### BACKGROUND

### Field of the Invention

The present disclosure relates to a liquid discharge head.

### Description of the Related Art

There is publicly known a liquid discharge head in which ink flows from a liquid container into a channel RB via an introduction opening. Part of the ink passes through a channel RA via the channel RB, is supplied to a pressure chamber, and is discharged from a nozzle communicating with the pressure chamber. Remaining part of the ink circulates through the annular channel RA.

### SUMMARY

In the above liquid discharge head, the channel RA through which ink circulates is disposed on the same X-Y plane. Bubbles mixed into the ink are thus not likely to be discharged, and may enter the nozzle via the pressure chamber from the channel RA. The nozzle may thus be clogged with bubbles, which may cause any failure in which no ink is discharged from the nozzle.

The present disclosure is made to solve such a problem, and an object of the present disclosure is to provide a liquid discharge head that is capable of discharging bubbles efficiently.

According to an aspect of the present disclosure, there is provided a liquid discharge head including: a channel unit and a pressure apply mechanism. The channel unit includes: a plurality of nozzles; a plurality of pressure chambers communicating with the respective nozzles and arranged in an arrangement direction; and a manifold. The pressure applying mechanism is configured to apply, to a liquid in the pressure chambers, discharge pressure for discharging the liquid from the nozzles. The manifold includes: a lower portion extending in the arrangement direction at a lower side of the pressure chambers and communicating with the pressure chambers to supply the liquid from an outside to the pressure chambers, a coupling portion having a lower end connected to the lower portion and an upper end positioned at an upper side of the lower end, and an upper portion having an end connected to the upper end of the coupling portion and extending in the arrangement direction at the upper side of the pressure chambers.

In the above configuration, the liquid is supplied from the lower portion to the pressure chambers and then discharged from the nozzles. The liquid not supplied to the pressure chambers flows from the lower portion into the upper portion positioned above the lower portion via the coupling portion. Here, bubbles in the liquid are pushed up by the flow of the liquid flowing upward, and then discharged efficiently from the lower portion. Accordingly, it is possible to provide the liquid discharge head capable of discharging bubbles efficiently.

The above object, other objects, features, and advantages of the present disclosure will become apparent from the following detailed description of the preferred embodiments with reference to the accompanying drawings.

### BRIEF DESCRIPTION OF THE DRAWINGS

FIG. 1 schematically depicts a liquid discharge apparatus 10 including a liquid discharge head 20.

FIG. 2 is a schematic plan view of the liquid discharge head in FIG. 1.

FIG. 3 is a cross-sectional view of the liquid discharge head taken along a line III-III in FIG. 2.

FIG. 4 is a cross-sectional view of the liquid discharge head taken along a line IV-IV in FIG. 2.

FIG. 5 is a cross-sectional view of part of a liquid discharge head 120.

FIG. 6 is a schematic plan view of a liquid discharge head 220.

FIG. 7 is a schematic plan view of a liquid discharge head 320.

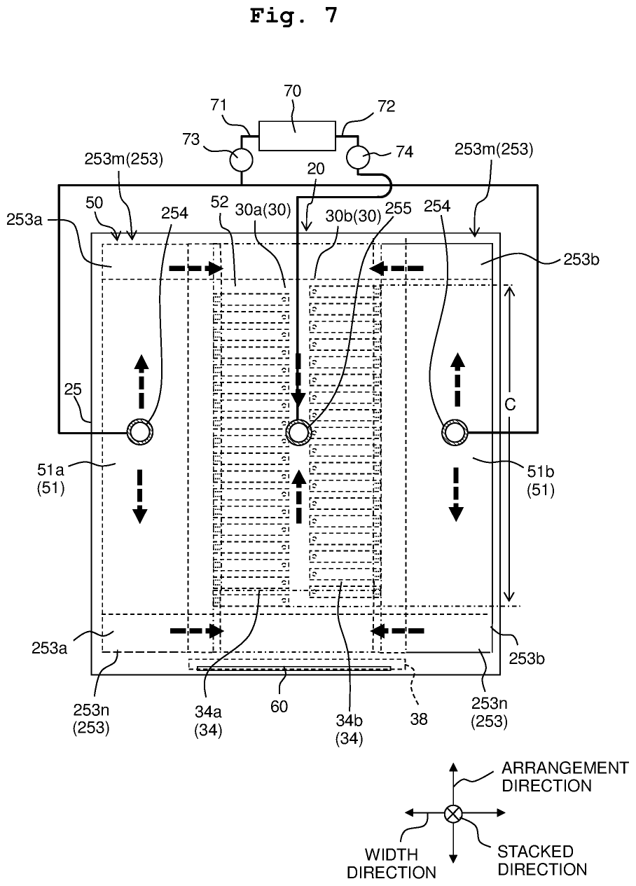

### DESCRIPTION OF THE EMBODIMENTS

Referring to the drawings, embodiments of the present disclosure are specifically explained below.

### First Embodiment

<Configuration of Liquid Discharge Apparatus>

A liquid discharge apparatus 10 including a liquid discharge head 20 (hereinafter referred to as a head) according to the first embodiment is an apparatus for discharging a liquid. In the following, explanation is made about an example in which the liquid discharge apparatus 10 is applied to an ink-jet printer for discharging liquid, such as ink. The liquid discharge apparatus 10 is not limited thereto.

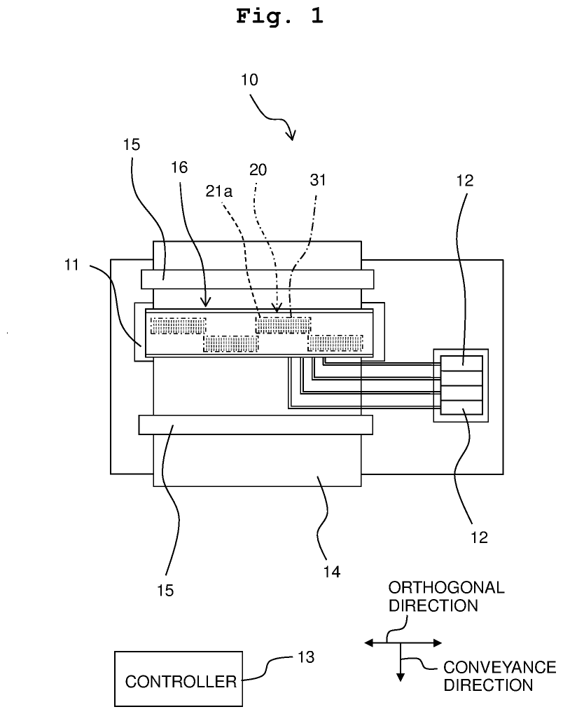

As depicted in FIG. 1, the liquid discharge apparatus 10 adopts a line-head type. The liquid discharge apparatus 10 includes a platen 11, a conveyer, a head unit 16, storage tanks 12, and a controller 13. The liquid discharge apparatus 10, however, is not limited to the line-head type, and may adopt any other type such as a serial-head type.

The platen 11 is a flat-plate member. A sheet 14 is placed on an upper surface of the platen 11. A distance between the sheet 14 and the head unit 16 is determined by the platen 11. The side closer to the head unit 16 than the platen 11 is referred to as an upper side, and an opposite side thereof is referred to as a lower side. The placement of the liquid discharge apparatus 10 is not limited thereto.

The conveyer includes, for example, two conveyance rollers 15 and a conveyance motor (not depicted). The platen 11 is interposed between the two conveyance rollers 15 in a conveyance direction. The two conveyance rollers 15, which are arranged parallel to each other, are coupled to the conveyance motor. Driving the conveyance motor rotates the conveyance rollers 15, thus conveying the sheet 14 on the platen 11 in the conveyance direction.

The head unit 16 has a length equal to or longer than the sheet 14 in an orthogonal direction (a sheet width direction) orthogonal to a direction (the conveyance direction) in which the sheet 14 is conveyed. The head unit 16 includes heads 20.

The head 20 includes a stacked body formed from a channel formation body and volume change portions. The inside of the channel formation body is formed having liquid channels. Nozzles 30 are opened in a lower surface (a discharge surface 21a) of the liquid formation body. The volume change portion is driven to change the volume of the liquid channel. The change in volume of the liquid channel vibrates a meniscus in the nozzle 30, thus discharging the liquid. Details of the head 20 are described below.

The storage tanks 12 are provided depending on kinds of inks. For example, the four storage tanks 12 respectively contain a black ink, a yellow ink, a cyan ink, and a magenta ink. Inks in the storage tanks 12 are supplied to respective nozzles 30.

The controller 13 includes a processor such as a CPU, a memory such as a RAM and ROM, and a driver IC such as ASIC. In the controller 13, the CPU receiving a request or a detection signal of a sensor controls the RAM to memorize data and outputs, to the ASIC, an execution instruction related to the request or the detection signal based on a program(s) memorized in the ROM. The ASIC controls each driver IC and executes an operation based on the execution instruction. Accordingly, the conveyance motor and the volume change portion(s) are driven.

For example, the controller 13 executes a discharge operation of the head units 16, a conveyance operation of the sheet 14, and the like. Ink is discharged from the nozzle(s) 30 of the head unit(s) 16 in the discharge operation. The sheet 14 is conveyed by a predefined amount in the conveyance direction in the conveyance operation. A print process proceeds by executing the discharge operation and the conveyance operation.

<Configuration of Head>

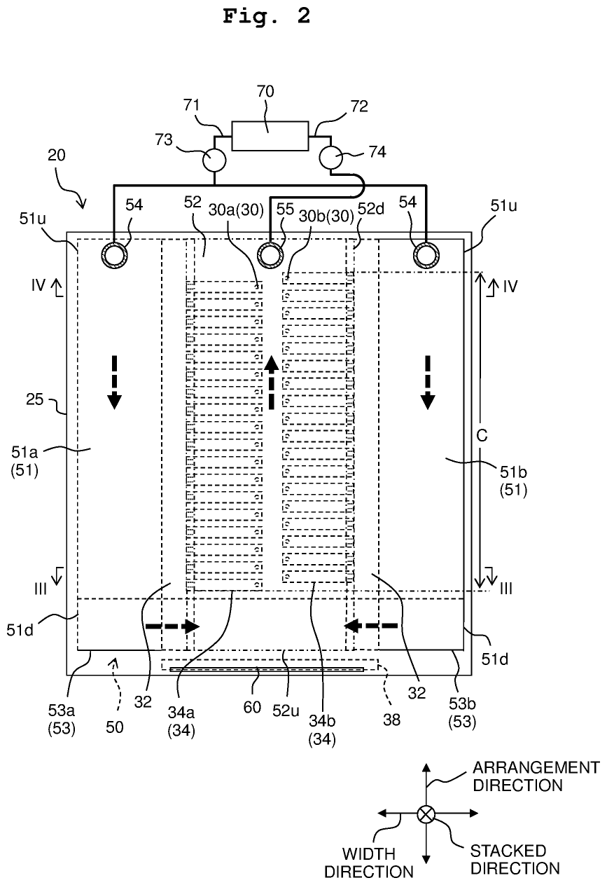

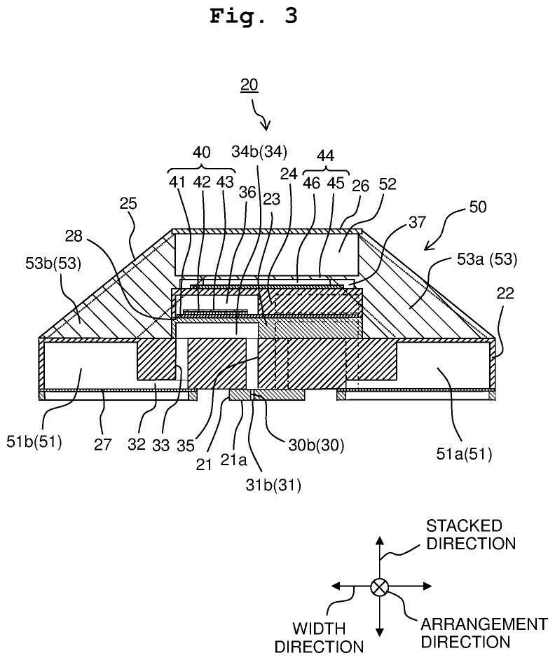

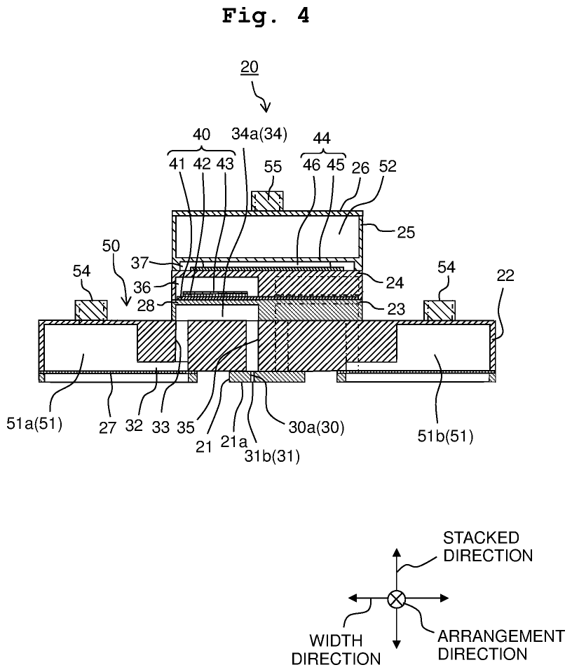

As described above, the head 20 includes the channel formation body and the volume change portions. As depicted in FIGS. 2 to 4, the channel formation body is a stacked body formed from plates. The volume change portions include piezoelectric elements 40 and a vibration plate 28.

The plates include a nozzle plate 21, a first channel plate 22, a second channel plate 23, a third channel plate 24, a fourth channel plate 25, and a fifth channel plate 26. The plates are stacked on top of each other in that order in a stacked direction.

Each of the plates is formed having holes and grooves in various sizes. The holes and grooves are joined to each other in the stacked body formed from the stacked plates. For example, the nozzles 30, individual channels, and a manifold 50 are formed as liquid channels. The manifold 50 has a lower portion 51, an upper portion 52, and a coupling portion 53. The lower portion 51 has a first lower portion 51a and a second lower portion 51b. Details of the respective portions are described below.

The nozzles 30 pass through the nozzle plate 21 in the stacked direction. The nozzles 30 are arranged in an arrangement direction to form a nozzle row in the discharge surface 21a of the nozzle plate 21. The arrangement direction is orthogonal to the stacked direction. The arrangement direction may be parallel to the sheet width direction or intersect with the sheet width direction. The direction intersecting with (e.g., orthogonal to) the stacked direction and the arrangement direction is referred to as a head width direction. In the following, the head width direction is simply referred to as a width direction.

The nozzles 30 include first nozzles 30a arranged to form a first nozzle row and second nozzles 30b arranged to form a second nozzle row. The first nozzle row and the second nozzle row are arranged parallel to each other at an interval in the width direction. The first nozzles 30a and the second nozzles 30b may be arranged mutually alternately in the arrangement direction. Or, the first nozzles 30a and the second nozzles 30b may be arranged side by side in the width direction.

Each individual channel includes a first individual channel connected to the first nozzle 30a and the first lower portion 51a and a second individual channel connected to the second nozzle 30b and the second lower portion 51b. The first individual channel and the second individual channel are arranged so that the first nozzle 30a and the second nozzle 30b are adjacent to each other in the width direction and the nozzles 30a and 30b are interposed between the first lower portion 51a and the second lower portion 51b in the width direction. Each of the first individual channel and the second individual channel includes a throttle channel 33, a pressure chamber 34, and a communication channel 35, those of which are arranged in that order in the width direction.

The first channel plate 22 includes the lower portion 51, the throttle channels 33, and the communication channels 35. The communication channels 35 pass through the first channel plate 22 in the stacked direction. Each communication channel 35 has an upper end connected to the pressure chamber 34 and a lower end connected to the nozzle 30.

The lower portion 51 is recessed from a lower surface of the first channel plate 22. The lower portion 51 extends in the arrangement direction. The lower portion 51 has, for example, an L-shaped cross section orthogonal to the arrangement direction. The lower portion 51 has a narrow portion and a wide portion 32 positioned at a lower side of the narrow portion. The wide portion 32 extends longer than the narrow portion in the width direction.

A lower opening of the lower portion 51 is covered with a damper film 27. The damper film 27 is a flexible film-like member. The damper film 27 is deformed to inhibit pressure fluctuation of the liquid in the lower portion 51.

Each throttle channel 33 extends upward from the wide portion 32 and passes through an upper portion of the first channel plate 22 in the stacked direction. The throttle channel 33 has a lower end connected to the wide portion 32 and an upper end connected to the pressure chamber 34.

The second channel plate 23 includes the pressure chambers 34. Each pressure chamber 34 is recessed from a lower surface of the second channel plate 23 and extends in the width direction. The pressure chamber 34 has a first end connected to the throttle channel 33 and a second end connected to the communication channel 35.

The second channel plate 23 includes the vibration plate 28 above the pressure chambers 34. The vibration plate 28 may be a plate different from the second channel plate 23. In this case, the pressure chambers 34 may pass through the second channel plate 23 in the stacked direction, and the vibration plate 28 may be stacked on the second channel plate 23 to cover upper openings of the pressure chambers 34.

The third channel plate 24 is a first plate in which a first accommodation space 36 for accommodating the piezoelectric elements 40 is formed. The first accommodation space 36 is disposed to overlap with the pressure chambers 34 in the stacked direction. The first accommodation 36 is recessed from a lower surface of the third channel plate 24 and extends in the arrangement direction.

The fourth channel plate 25 is a second plate in which a second accommodation space 37 and the upper portion 52 are formed. The second accommodation space 37 is formed to overlap with the first accommodation space 36 in the stacked direction. The second accommodation space 37 is recessed from a lower surface of the fourth channel plate 25 and extends in the arrangement direction. The upper portion 52 is recessed from an upper surface of the fourth channel plate 25 and extends in the arrangement direction. The upper portion 52 is disposed to overlap with the second accommodation space 37 in the stacked direction.

The upper portion 52 is separated from the second accommodation space 37 in the stacked direction by a partition wall of the fourth channel plate 25. An electronic circuit 44 is accommodated in the second accommodation space 37. The electronic circuit 44 includes a substrate 45 and a driver IC 46 mounted on the substrate 45.

The fifth channel plate 26 is stacked on the fourth channel plate 25 to cover an upper opening of the upper portion 52.

The piezoelectric element 40 includes a common electrode 41, a piezoelectric layer 42, and an individual electrode 43, those of which are arranged on the vibration plate 28 in that order.

The individual electrodes 43 are provided for the respective pressure chambers 34 and disposed on the pressure chambers 34. The common electrode 41 covers an entire surface of the vibration plate 28. One piezoelectric element 40 is thus configured by one individual electrode 43, the common electrode 41, and a portion of the piezoelectric layer 42 (active portion) interposed between the individual electrode 43 and the common electrode 41.

The individual electrodes 43 are electrically connected to the driver IC 46. The driver IC 46 receives a control signal from the controller 13 (FIG. 1), generates a driving signal (voltage signal), and applies it to the individual electrodes 43. The common electrode 41 is always kept at the ground potential.

In response to the driving signal, the active portion of the piezoelectric layer 42 expands and contracts in a planar direction together with the two electrodes 41 and 43. This deforms the vibration plate 28 in a direction in which the volume of the pressure chamber 34 increases and decreases. Discharge pressure for discharging the liquid from the nozzle 30 is thus applied to the pressure chamber 34.

<Configuration of Manifold>

The manifold 50 is a common channel through which the liquid is supplied to the individual channels. The manifold 50 is branched into the individual channels. The manifold 50 has the lower portion 51, the upper portion 52, and the coupling portion 53.

The lower portion 51 has the first lower portion 51a connected to the first individual channels and the second lower portion 51b connected to the second individual channels. The first lower portion 51a and the second lower portion 51b are arranged in the width direction so that the first individual channels and the second individual channels are interposed therebetween.

The pressure chambers 34 include first pressure chambers 34a (pressure chambers 34 belonging to the first individual channels) arranged to form a first row and second pressure chambers 34b (pressure chambers 34 belonging to the second individual channels) arranged to form a second row. In an arrangement area C, the first and second pressure chambers 34a and 34b are arranged in the arrangement direction at an interval in the width direction.

The lower portion 51 is disposed below the pressure chambers 34. The wide portion 32 of the lower portion 51 is connected to the throttle channels 33. The lower portion 51 communicates with the pressure chambers 34 via the throttle channels 33. The lower portion 51 extends in the arrangement direction along the pressure chambers 34 and communicates with the pressure chambers 34. The liquid is thus supplied from the outside to the pressure chambers 34 through the lower portion 51. The lower portion 51 extends beyond the arrangement area C for the pressure chambers 34 in the arrangement direction. A first end (an upstream-side lower end 51u) and a second end (a downstream-side lower end 51d) in the arrangement direction of the lower portion 51 are positioned outside the arrangement area C.

Lower ports 54 are connected to the upstream-side lower end 51u by through holes. The through holes pass through the upper portion of the first channel plate 22 from the upstream-side lower end 51u toward the upper side. The lower ports 54 have, for example, a cylindrical shape. The lower ports 54 are attached to an upper surface of the first channel plate 22 to surround the through holes. The lower ports 54 protrude upward from the upper surface of the first channel plate 22. This allows the upstream-side lower end 51u to communicate with internal spaces of the lower ports 54 through the through holes. The lower ports 54 may be formed integrally with the first channel plate 22.

The downstream-side lower end 51d is connected to the coupling portion 53 via an upper end opening. The upper end opening passes through the upper portion of the first channel plate 22 from the downstream-side lower end 51d.

The coupling portion 53 has a first coupling portion 53a connected to the downstream-side lower end 51d of the first lower portion 51a and a second coupling portion 53b connected to downstream-side lower end 51d of the second lower portion 51b.

The coupling portion 53 is disposed at an end opposite to the lower ports 54 in the arrangement direction of the fourth channel plate 25. In the arrangement area C, the fourth channel plate 25 is stacked on the third channel plate 24. Outside the arrangement area C, the fourth channel plate 25 is stacked on the first channel plate 22. The coupling portion 53 is connected to the lower portion 51 outside the arrangement area C.

The coupling portion 53 extends in the width direction. Both ends (lower end and upper end) in a longitudinal direction of the coupling portion 53 are open, and a lower end opening of the coupling portion 53 is connected to the upper end opening of the lower portion 51. The coupling portion 53 is inclined linearly so that its upper end is closer to a center portion in the width direction than its lower end. The first coupling portion 53a and the second coupling portion 53b are thus arranged in a truncated chevron shape (an inverted substantially V-shape) so that they are arranged to be line-symmetric with respect to the center portion in the width direction.

The upper portion 52 is disposed between the first lower portion 51a and the second lower portion 51b in the width direction. The upper portion 52 is stacked on the second accommodation space 37 in the stacked direction. The upper portion 52 is thus disposed above the pressure chambers 34, and the electronic circuit 44 in the second accommodation space 37 is disposed between the piezoelectric elements 40 and the upper portion 52.

The upper portion 52 extends beyond the arrangement area C for the pressure chambers 34 in the arrangement direction. A first end (a downstream-side upper end 52d) and a second end (an upstream-side upper end 52u) in the arrangement direction of the upper portion 52 are positioned outside the arrangement area C. For example, the length of the upper portion 52 in the arrangement direction is equal to the length of the lower portion 51, and the cross-sectional area of the upper portion 52 orthogonal to the arrangement direction is larger than the cross-sectional area of the lower portion 51. For example, the cross-sectional area of the upper portion 52 is twice as large as the cross-sectional area of the lower portion 51.

An upper port 55 is connected to the downstream-side upper end 52d through a through hole. The through hole passes through an upper portion of the fifth channel plate 26 from the downstream-side upper end 52d to the upper side. The upper port 55 has, for example, a cylindrical shape. The upper port 55 is attached to an upper surface of the fifth channel plate 26 to surround the periphery of the through hole. The upper port 55 protrudes upward from the upper surface of the fifth channel plate 26. This allows the downstream-side upper end 52d to communicate with an internal space of the upper port 55 through the through hole. The upper port 55 may be formed integrally with the fifth channel plate 26.

The upstream-side upper end 52u is disposed at an end opposite to the upper port 55 in the arrangement direction. The upstream-side upper end 52u is connected to the coupling portion 53 via a side-end opening pair. A first side-end opening included in the side-end opening pair is connected to an upper end opening of the first coupling portion 53a , and a second side-end opening included in the side-end opening pair is connected to an upper end opening of the second coupling portion 53b. The side-end opening pair face each other in the width direction. The first coupling portion 53a , the upstream-side upper end 52u , and the second coupling portion 53b extend along the same straight line in the width direction.

The upper portion 52 communicates with the first lower portion 51a via the first coupling portion 53a. The upper portion 52 communicates with the second lower portion 51b via the second coupling portion 53b. The manifold 50 includes the first lower portion 51a extending to the second side in the arrangement direction, the first coupling portion 53a extending upward, and the upper portion 52 extending to the first side in the arrangement direction. Further, the manifold 50 includes the second lower portion 51b extending to the second side in the arrangement direction, the second coupling portion 53b extending upward, and the upper portion 52 extending to the first side in the arrangement direction.

<Flow of Liquid in Manifold>

As depicted in FIG. 2, the lower ports 54 are connected to the subtank 70 by a supply pipe 71. A pressurizing pump 73 is provided in the supply pipe 71. The upper port 55 is connected to the subtank 70 by a return pipe 72, and a negative pressure pump 74 is provided in the return pipe 72. For example, the subtank 70 is disposed on the head 20 and is connected to the storage tanks 12 (FIG. 1).

When each of the pumps 73 and 74 is driven, the liquid from the subtank 70 passes through the supply pipe 71 and flows into the upstream-side lower end 51u via the lower ports 54. Then, the liquid flows through the lower portion 51 toward the second side in the arrangement direction. Part of the liquid flows into the individual channel(s). The liquid flowing into the individual channel(s) passes through the throttle channel(s) 33, the pressure chamber(s) 34, and the communication channel(s) 35 in that order, reaches the nozzle(s) 30, and is discharged from the nozzle(s) 30. The remaining liquid flows through the lower portion 51 toward the downstream-side lower end 51d and flows into the coupling portion 53 through the downstream-side lower end 51d.

In the coupling portion 53, the liquid flows along a slope inclined upward from the lower portion 51 toward the pressure chambers 34 in the width direction. Then, the liquid flows from the coupling portion 53 into the upstream-side upper end 52u. The upstream-side upper end 52u allows the liquid flowing therein from the first lower portion 51a through the first coupling portion 53a and the liquid flowing therein from the second lower portion 51b through the second coupling portion 53b to merge together.

The merged liquid flows through the upper portion 52 toward the first side in the arrangement direction. Then, the liquid flows out of the downstream-side upper end 52d via the upper port 55 and returns to the subtank 70 through the return pipe 72. Accordingly, the liquid not flowing into the individual channel(s) circulates between the subtank 70 and the manifold 50.

<Action, Functions, and Effects>

The head 20 includes the manifold 50 and the pressure chambers 34 arranged in the arrangement direction to which the discharge pressure for discharging the liquid from the nozzles 30 is applied. The manifold 50 has the lower portion 51, the coupling portion 53, and the upper portion 52. The lower portion 51 extends in the arrangement direction at the lower side of the pressure chambers 34. The lower portion 51 communicates with the pressure chambers 34 and the liquid is supplied from the outside to the pressure chambers 34 through the lower portion 51. The coupling portion 53 has the lower end connected to the end (downstream-side lower end 51d) of the lower portion 51 and the upper end positioned on the upper side of the lower end. The end (upstream-side upper end 52u) of the upper portion 52 is connected to the upper end of the coupling portion 53. The upper portion 52 extends in the arrangement direction at the upper side of the pressure chamber 34.

In this configuration, the liquid not supplied to the pressure chambers 34 flows through the coupling portion 53 extending upward from the lower portion 51, and then flows into the upper portion 52. Bubbles in the liquid are thus pushed up by the flow of the liquid flowing upward, and then discharged efficiently from the lower portion 51 through which the liquid is supplied to the pressure chambers 34. This inhibits the failure in which no liquid is discharged from the nozzles 30 that may otherwise be caused by clogging of the nozzles 30 owing to the bubbles entering the nozzles 30 from the lower portion 51 via the pressure chambers 34.

Further, the coupling portion 53 causes the liquid to flow upward from the lower portion 51 to the upper portion 52. This diffuses settling contents of the liquid, thus inhibiting the sedimentation of contents. Unevenness of the concentration distribution of the liquid discharged from the nozzles 30 can be thus reduced.

In the head 20, the pressure chambers 34 include the first pressure chambers 34a arranged to form the first row and the second pressure chambers 34b arranged to form the second row. The lower portion 51 has the first lower portion 51a that communicates with the first pressure chambers 34a , and the second lower portion 51b that communicates with the second pressure chambers 34b. The first lower portion 51a and the second lower portion 51b are arranged to interpose the upper portion 52 therebetween in the direction (width direction) intersecting with the arrangement direction.

In this configuration, only one upper portion 52 is provided for the first lower portion 51a and the second lower portion 51b , thus downsizing the head 20. The upper portion 52 is disposed between the first lower portion 51a and the second lower portion 51b in the width direction, and the liquid is equally distributed to the first lower portion 51a and the second lower portion 51b.

In the head 20, the coupling portion 53 has the first coupling portion 53a connected to the first lower portion 51a and the second coupling portion 53b connected to the second lower portion 51b. The first coupling portion 53a and the second coupling portion 53b extend along the same straight line and are connected to the upper portion 52.

In this configuration, the liquid flows into the lower end of the coupling portion 53 through the end of the lower portion 51, passes through the coupling portion 53, and flows into the end of the upper portion 52 through the upper end of the coupling portion 53. The liquid flows along the end surfaces of the lower portions 51a and 51b , the end surface of the coupling portion 53, and the end surface of the upper portion 52, thus allowing the liquid to flow without stagnation and inhibiting the accumulation of bubbles and the sedimentation of contents of the liquid.

In the head 20, the manifold 50 includes the lower ports 54 connected to the first end (upstream-side lower end 51u) in the longitudinal direction of the lower portion 51, and the upper port 55 connected to the first end (downstream-side upper end 52d) in the longitudinal direction of the upper portion 52. The coupling portion 53 is connected to the second end (downstream-side lower end 51d) of the lower portion 51 and the second end (upstream-side upper end 52u) of the upper portion 52.

In this configuration, the liquid flows into the first end of the lower portion 51 through the lower ports 54 and passes through the lower portion 51 from the first end to the second end. Then, the liquid flows from the second end of the lower portion 51 to the second end of the upper portion 52 via the coupling portion 53 and passes through the upper portion 52 from the second end to the first end. As described above, the liquid flows through the manifold 50 in one direction along the longitudinal direction, allowing the liquid to flow without stagnation as well as inhibiting the accumulation of bubbles and the sedimentation of contents of the liquid.

The head 20 includes the piezoelectric elements 40 and the electronic circuit 44 that outputs the driving signal to the piezoelectric elements 40. The piezoelectric elements 40 are disposed above the pressure chambers 34 via the vibration plate 28, and the electronic circuit 44 is disposed between the piezoelectric elements 40 and the upper portion 52.

In this configuration, the electronic circuit 44 is cooled by the liquid flowing through the upper portion 52 positioned thereabove. This inhibits the operation failure due to the heat generation of the electronic circuit 44. Further, the upper portion 52 is disposed on the electronic circuit 44, which downsizes the head 20 in the direction intersecting with an up-down direction.

### First Modified Embodiment

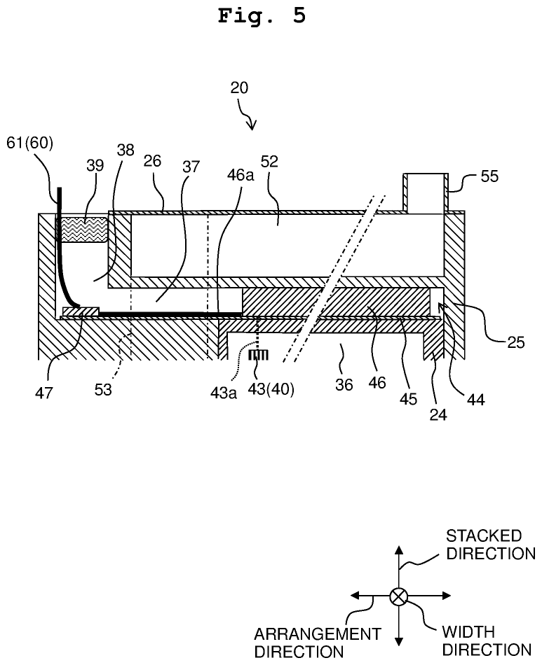

In a head 120 according to the first modified embodiment, as depicted in FIG. 5, the fourth channel plate 25 may have a communication hole 38. Any other configurations, action, functions, and effects are the same as those as described above, and thus explanation therefor is omitted.

The communication hole 38 is disposed further away from the upper port 55 than the upper portion 52 in the arrangement direction. The communication hole 38 is recessed downward from the upper surface of the fourth channel plate 25. The communication hole 38 communicates with the second accommodation space 37.

The communication hole 38 thus has an upper opening, a lower opening, and an inner surface in the fourth channel plate 25. The upper opening is opened in the upper surface of the fourth channel plate 25. The lower opening is disposed on the lower side of the upper opening such that the lower opening overlaps with the upper opening. The lower opening is connected to the second accommodation space 37. The inner surface extends in the stacked direction between the upper opening and the lower opening and surrounds the periphery of the communication hole 38, thereby forming the communication hole 38.

On a bottom surface of the second accommodation space 37, connection portions 47 are arranged in a range below the communication hole 38 and overlapping with the upper opening and the lower opening in the up-down direction. The connection portions 47 are arranged at intervals in the width direction. For example, the connection portions 47 are mounted on the substrate 45 of the electronic circuit 44. Each connection portion 47 is connected to the driver IC 46 by a first lead wire 46a.

The driver IC 46 is connected to each individual electrode 43 by a second lead wire 43a. The second lead wire 43a is connected to each individual electrode 43 in the first accommodation space 36 through a through electrode of the third channel plate 24.

Each connection portion 47 is electrically connected to an external trace 61. The external trace 61 is, for example, a trace of a film-like substrate 60. A first end thereof is connected to the connection portion 47, and a second end thereof is connected to the controller 13 disposed outside, or the like. The film-like substrate 60 is made using polyimide or the like. The film-like substrate 60 is a flexible printed circuit board (FPC) that is thin and flexible.

The film-like substrate 60 is inserted from the outside into the communication hole 38 through the upper opening of the communication hole 38. The film-like substrate 60 extends downward through the communication hole 38. The external trace 61 is connected to each connection portion 47. In this configuration, the driver IC 46 of the electronic circuit 44 converts the control signal from the controller 13 into the driving signal for the piezoelectric element 40, outputs the driving signal to the piezoelectric element 40, thereby controlling the driving of the piezoelectric element 40.

When the film-like substrate 60 is connected to each connection portion 47, the film-like substrate 60 is disposed along the inner surface of the communication hole 38. In this configuration, the film-like substrate 60 extends upward from the connection portion 47 while being supported by the inner surface of the communication hole 38, and protrudes upward from the upper opening of the communication hole 38. A sealing material 39 is injected from the upper opening into the communication hole 38 to close the upper opening. The communication hole 38 and the second accommodation space 37 communicating therewith are thus sealed with the sealing material 39. Epoxy resin, silicone resin, or the like may be used for the sealing material 39.

In the head 120, the connection portions 47 disposed on the electronic circuit 44 to which the external traces 61 are connected are disposed further away from the upper port 55 than the upper portion 52 in the longitudinal direction of the upper portion 52. In this configuration, the upper port 55 and the lower ports 54 arranged on the same side do not interfere with the connection of the external traces 61 to the connection portions 47, resulting in easy connection.

If the upper port 55 and the connection portions 47 are provided on the same side in the longitudinal direction, the connection portions 47 may protrude beyond the upper port 55 to avoid the upper port 55. This may make the dimension of the head 120 large. Providing the upper port 55 and the connection portions 47 at opposite ends in the longitudinal direction allows the connection portions 47 to be provided regardless of the position of the upper port 55. This inhibits the head 120 from being enlarged in size.

The head 120 includes the first plate (third channel plate 24) formed having the first accommodation space 36 that accommodates the piezoelectric elements 40, and the second plate (fourth channel plate 25) stacked on the first plate and formed having the second accommodation space 37 that accommodates the electronic circuit 44, the communication hole 38 that communicates with the second accommodation space 37, and the upper portion 52. The communication hole 38 is sealed with the sealing material 39 in a state where the external traces 61 connected to the connection portions 47 of the electronic circuit 44 are inserted into and extend through the communication hole 38.

In this configuration, the external traces 61 connected to the electronic circuit 44 are inserted into the communication hole 38 through the second accommodation space 37. The communication hole 38 is sealed with the sealing material 39 in the state where the external traces 61 are inserted into and extend through the communication hole 38. The periphery of each connection portion 47 of the electronic circuit 44 connected to the external trace 61 is covered with the second plate and the sealing material 39, thus inhibiting liquid mist or the like from adhering to each connection portion 47.

In the head 120, the communication hole 38 is opened in an upper surface of the second plate (third channel plate 24). This allows the sealing material 39 to be injected into the communication hole 38 from above, resulting in excellent workability.

In the head 120, the communication hole 38 extends downward from the opening in the upper surface of the second plate (third channel plate 24). In this configuration, the external traces 61 inserted into and extending through the communication hole 38 are supported by the inner surface of the through hole. Thus, it is not necessary to support the external traces 61 at the assembly of the head 120, which results in excellent workability.

### Second Modified Embodiment

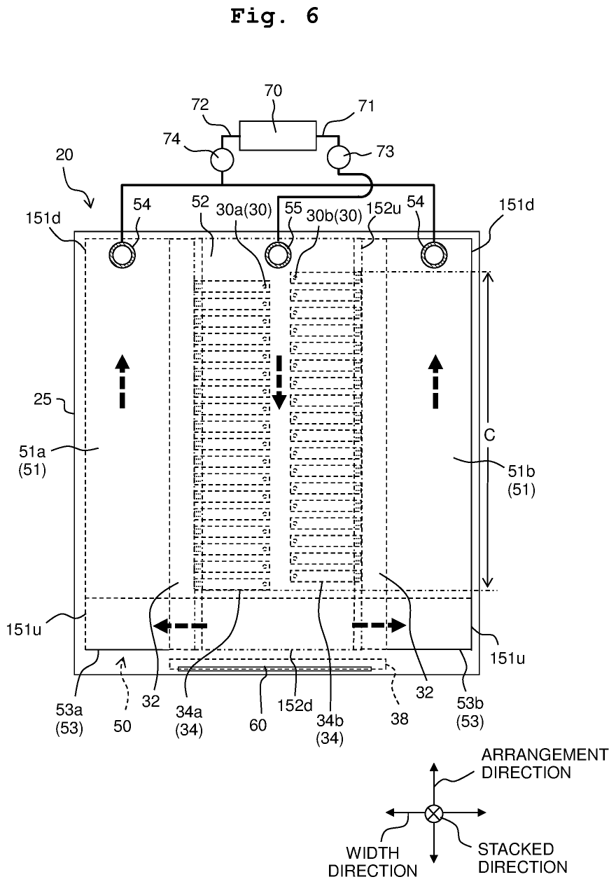

In a head 220 according to the second modified embodiment, as depicted in FIG. 6, the lower ports 54 may be connected to the return pipe 72 and the upper port 55 may be connected to the supply pipe 71. In this case, the first end of the lower portion 51 is a downstream-side lower end 151d , and the second end is an upstream-side lower end 151u. The first end of the upper portion 52 is an upstream-side upper end 152u , and the second end is a downstream-side upper end 152d. Any other configurations, action, functions, and effects are the same as those as described above, and thus explanation therefor is omitted.

Specifically, when the pressurizing pump 73 of the supply pipe 71 and the negative pressure pump 74 of the return pipe 72 are driven, the liquid from the subtank 70 flows through the supply pipe 71, flows into the upstream-side upper end 152u via the upper port 55, passes through the upper portion 52 toward the second side in the arrangement direction, and flows into the coupling portion 53 through the downstream-side upper end 152d.

In the coupling portion 53, the liquid flows along a slope inclined downward from the upper portion 52 toward the side away from the pressure chambers 34 in the width direction. Then, the liquid flows from the coupling portion 53 into the upstream-side lower end 151u. Here, the liquid branches into a liquid flowing from the upper portion 52 into the first lower portion 51a through the first coupling portion 53a and a liquid flowing from the upper portion 52 into the second lower portion 51b through the second coupling portion 53b.

The liquid flows through the lower portion 51 toward the first side in the arrangement direction. Here, part of the liquid is supplied to the nozzle(s) 30 via the pressure chamber(s) 34 and discharged from the nozzle(s) 30. The remaining liquid flows to the downstream-side lower end 151d , flows out through the lower ports 54, and returns to the subtank 70 through the return pipe 72. Accordingly, the liquid not supplied to the nozzle(s) 30 circulates between the subtank 70 and the manifold 50.

During the circulation, the coupling portion 53 allows the liquid to flow downward from the upper portion 52 to the lower portion 51. This diffuses settling contents of the liquid, thus inhibiting the sedimentation of contents.

### Second Embodiment

In a head 320 according to the second embodiment, positions of an upper port 255 and lower ports 254 as well as arrangement of a coupling portion 253 are different from those described above. Any other configurations, action, functions, and effects are the same as those as described above, and thus explanation therefor is omitted.

Specifically, the manifold 50 has the lower ports 254 connected to a center portion in the longitudinal direction of the lower portion 51 and the upper port 255 connected to a center portion in the longitudinal direction of the upper portion 52.

The coupling portion 253 has a first coupling portion 253m connected to the first end of the lower portion 51 and the first end of the upper portion 52 in the arrangement direction, and a second coupling portion 253n connected to the second end of the lower portion 51 and the second end of the upper portion 52 in the arrangement direction.

The first coupling portion 253m has a first coupling portion 253a at the first side and a second coupling portion 253b at the first side. The first coupling portion 253a at the first side is connected to the upper end opening at the first end of the first lower portion 51a and one of the side-end openings at the first end of the upper portion 52. The second coupling portion 253b at the first side is connected to the upper end opening at the first end of the second lower portion 51b and the other of the side-end openings at the first end of the upper portion 52.

The second coupling portion 253n has a first coupling portion 253a at the second side and a second coupling portion 253b at the second side. The first coupling portion 253a at the second side is connected to the upper end opening at the second end of the first lower portion 51a and one of the side-end openings at the second end of the upper portion 52. The second coupling portion 253b at the second side is connected to the upper end opening at the second end of the second lower portion 51b and the other of the side-end openings at the second end of the upper portion 52.

The first lower portion 51a thus communicates with the upper portion 52 through the first coupling portion 253a at the first side and the first coupling portion 253a at the second side. The first lower portion 51a has the lower port 254 between the first coupling portion 253a at the first side and the first coupling portion 253a at the second side in the arrangement direction. The second lower portion 51b communicates with the upper portion 52 through the second coupling portion 253b at the first side and the second coupling portion 253b at the second side. The second lower portion 51b has the lower port 254 between the second coupling portion 253b at the first side and the second coupling portion 253b at the second side in the arrangement direction.

In the head 320 according to the second embodiment, for example, the lower ports 254 are connected to the subtank 70 by the supply pipe 71, and the upper port 255 is connected to the subtank 70 by the return pipe 72. In this configuration, when the pump of each pipe is driven, the liquid from the subtank 70 passes through the supply pipe 71 and flows into a center portion of the lower portion 51 via the lower ports 254. Then, the liquid from the lower ports 254 branches into a liquid flowing toward the first end of the lower portion 51 in the arrangement direction and a liquid flowing toward the second end of the lower portion 51 in the arrangement direction. Part of the liquid is supplied to the nozzle(s) 30 via the pressure chamber(s) 34 and discharged from the nozzle(s) 30.

The first coupling portion 253m allows the liquid not discharged from the nozzle(s) 30 and flowing toward the first end of the lower portion 51 to flow along a slope inclined upward toward the upper portion 52 and flow into the first end of the upper portion 52. The second coupling portion 253n allows the liquid not discharged from the nozzle(s) 30 and flowing toward the second end of the lower portion 51 to flow along a slope inclined upward toward the upper portion 52 and flow into the second end of the upper portion 52.

Then, the liquid flows from the both ends of the upper portion 52 to the center portion thereof, flows out through the upper port 255, returns to the subtank 70 through the return pipe 72. As described above, the liquid not supplied to the nozzles 30 circulates between the subtank 70 and the manifold 50.

In the head 320, the lower ports 254 are disposed at the center portion in the longitudinal direction of the lower portion 51, and the upper port 255 is disposed at the center portion in the longitudinal direction of the upper portion 52. This shortens liquid channels in the longitudinal direction of the lower portion 51 and the upper portion 52, thus reducing the pressure loss of the liquid in the lower portion 51 and the upper portion 52.

In the head 320 according to the second embodiment, the fourth channel plate 25 may include the communication hole 38 like the first modified embodiment. In this case, the communication hole 38 is disposed at the outside of any one of the ends in the arrangement direction of the upper portion 52. The communication hole 38 is recessed downward from the upper surface of the fourth channel plate 25 to communicate with the second accommodation space 37.

In the head 320 according to the second embodiment, the lower ports 254 may be connected to the return pipe 72 and the upper port 255 may be connected to the supply pipe 71 like the second modified embodiment. In this case, the liquid is supplied from the outside to the upper portion 52 via the upper port 255 and then discharged from the lower portion 51 to the outside via the lower ports 254.

From the above description, many modifications and other embodiments of the present disclosure are apparent to those skilled in the art. The above description should thus be interpreted as just examples, and is provided to teach those skilled in the art the mode for carrying out the present disclosure. Details about the configurations and/or the functions described above may be substantially changed without departing from the gist and scope of the present disclosure.

The liquid discharge head of the present disclosure is useful as a liquid discharge head capable of discharging bubbles efficiently, and the like.

What is claimed is:

1. A liquid discharge head comprising:
a channel unit including:
a plurality of nozzles;
a plurality of pressure chambers communicating with the respective nozzles and arranged in an arrangement direction; and
a manifold; and
a pressure applying mechanism configured to apply, to a liquid in the pressure chambers, discharge pressure for discharging the liquid from the nozzles,
wherein the manifold includes:
a lower portion extending in the arrangement direction at a lower side of the pressure chambers and communicating with the pressure chambers to supply the liquid from an outside to the pressure chambers;
a coupling portion having a lower end connected to the lower portion and an upper end positioned at an upper side of the lower end; and
an upper portion having an end connected to the upper end of the coupling portion and extending in the arrangement direction at the upper side of the pressure chambers.

2. The liquid discharge head according to claim 1, wherein the pressure chambers include a plurality of first pressure chambers arranged to form a first row and a plurality of second pressure chambers arranged to form a second row,
wherein the lower portion includes a first lower portion communicating with the first pressure chambers and a second lower portion communicating with the second pressure chambers, and
wherein the first lower portion and the second lower portion are arranged such that the upper portion is interposed therebetween in a direction intersecting with the arrangement direction.

3. The liquid discharge head according to claim 2, wherein the coupling portion includes a first coupling portion connected to the first lower portion and a second coupling portion connected to the second lower portion, and
wherein the first coupling portion and the second coupling portion extend along an identical straight line and connected to the upper portion.

4. The liquid discharge head according to claim 1, wherein the manifold includes:
a lower port connected to a center portion in a longitudinal direction of the lower portion; and
an upper port connected to a center portion in a longitudinal direction of the upper portion.

5. The liquid discharge head according to claim 1, wherein the manifold includes:
a lower port connected to a first end in a longitudinal direction of the lower portion; and
an upper port connected to a first end in a longitudinal direction of the upper portion, and
wherein the coupling portion is connected to a second end of the lower portion and a second end of the upper portion.

6. The liquid discharge head according to claim 5, wherein the pressure applying mechanism includes:
a vibration plate;
a plurality of piezoelectric elements disposed above the pressure chambers via the vibration plate; and
an electronic circuit disposed between the piezoelectric elements and the upper portion and configured to output a driving signal to the piezoelectric elements.

7. The liquid discharge head according to claim 6, wherein the electronic circuit includes a connection portion to which an external trace is connected, and
wherein the connection portion is disposed further away from the upper port than the upper portion in the longitudinal direction of the upper portion.

8. The liquid discharge head according to claim 7, further comprising:
a first plate formed having a first accommodation space in which the piezoelectric elements are accommodated; and
a second plate stacked on the first plate and formed having a second accommodation space in which the electronic circuit is accommodated, a communication hole communicating with the second accommodation space, and the upper portion,
wherein the external trace connected to the connection portion is inserted into and extends through the communication hole, and
wherein a portion of the communication hole into which the external trace is inserted is sealed with a sealing material.

9. The liquid discharge head according to claim 8, wherein the communication hole is opened in an upper surface of the second plate.

10. The liquid discharge head according to claim 9, wherein the communication hole extends downward from the opening in the upper surface of the second plate.
